(19) United States
(12) Patent Application Publication
(10) Pub. No.: US 2014/0285493 A1
(43) Pub. Date: Sep. 25, 2014

(54) METHOD AND APPARATUS TO DISPLAY THE TIME OF DAY AS A MATHEMATICAL EXPRESSION

(71) Applicant: Lawrence James Polyak, San Jose, CA (US)

(72) Inventor: Lawrence James Polyak, San Jose, CA (US)

(21) Appl. No.: 13/849,780

(22) Filed: Mar. 25, 2013

(51) Int. Cl. G06F 17/10; G06T 11/60

(52) U.S. Cl. CPC G06F 17/10; G06T 11/60
USPC 345/467; 708/490

(57) ABSTRACT

A method of showing the time of day by displaying a mathematical expression. A display capable of showing numbers, letters, and other characters is used. A plurality of numbers in conjunction with one or more mathematical symbols is displayed to create a mathematical expression which changes at regular intervals. Evaluating the expression according to mathematical conventions yields a number that represents the current time of day. Such a device will serve to stimulate the mind by providing a different mental exercise at regular intervals, with the built-in reward for success being the ability to determine the time of day. Expressions can be easy or difficult to evaluate, geared to any number of different types and abilities of viewers.

### CROSS-REFERENCE TO RELATED APPLICATIONS

Not applicable

### FEDERALLY SPONSORED RESEARCH

Not applicable

### SEQUENCE LISTING OR PROGRAM

Not applicable

### BACKGROUND

This application relates to digital timepieces such as clocks, and the field of horology, the science and history of keeping and displaying the time. More particularly, this application relates to a timepiece which displays a mathematical expression which must be evaluated in order to determine the time of day.

U.S. Pat. No. 5,896,348 states “Throughout history, a wide variety of devices have been used to measure and mark the passage of time.” and “Because keeping track of time is so important for most people and because timepieces are so universal, there is a constant need for novel, interesting, and creative methods and decorative devices for keeping and displaying the time.”

### PRIOR ART

U.S. Pat. No. 5,896,348 describes a timepiece where the hours, tens of minutes, and minutes are displayed in groups of three different objects, each of which can be on or off. The number of objects that are on in each group represents the number of hours, tens of minutes, and minutes, which comprise the current time.

U.S. Pat. No. 3,841,082 describes a clock using an array of lights which displays the time according to the binary number system. U.S. Pat. No. 3,854,279 discloses an apparatus for indicating time using a plurality of lamps having different colors corresponding to different times of the day. U.S. Pat. No. 4,254,489, 4,075,826, 4,120,148, 4,448,544, 4,207,734, and 4,074,515 all disclose electronic circuitry controlling operation of a digital timepiece. U.S. Pat. No. 4,448,544 states that “Certainly one of the most outstanding features of a digital timepiece is the relative ease with which a person viewing the timepiece can communicate the time to a person or persons who cannot see it.”

The method of displaying time in this application is different in that it is difficult and requires some thought to be able to determine the time of day, that is, a mathematical expression must be evaluated.

Novelty analog clocks exist with hour and minute hands on a background or face that has, instead of the standard numerals 1 through 12, twelve different math equations that represent the numbers 1 through 12. for example 3*3 for 9. These differ from the method and apparatus in this application due to the fact that time is still read by the position of the hands on the face. The face of the clock could be blank and the time could still be read as a normal analog clock. In addition, the twelve equations are printed on the face and do not change. The method and apparatus in this application will change its display at various intervals, such as each minute, to present a new equation. There are no traditional clock hands or other indicators. The viewer must evaluate the mathematical expression in order to determine the time of day.

U.S. Pat. No. 4,448,544 describes a timepiece which displays two numbers with a minus sign in between such as 8−12. In that patent, this is interpreted as 12 minutes before the hour of 8 or 7:48. The expression displayed in that patent is not evaluated in a normal mathematical fashion, as it is in this application. Also, in that patent, the number on the left is always either the current or next hour and the number on the number on the right is either the minutes before or after the hour. In this method and apparatus, the numbers displayed may not have any relation to the current hours and minutes. The expression must be evaluated in order to determine the hours and minutes.

There are other clocks presently on the market which display time in non-standard formats. One displays the time using the binary number system instead of the decimal number system. Another has several modes of time display including using the binary, hexadecimal or octal number systems, and one displays what is called “Unix time” (the number of seconds since Jan. 1, 1970). All of these simply display a number representing the time. These types of timepieces appeal to a relatively small number of people, mainly computer programmers who are familiar with different numbering systems other than the standard base ten.

The method and apparatus of this application will appeal to a much wider audience, since almost everyone can perform some level of mathematic functions to at least some degree. A plurality of numbers along with one or more mathematical function symbols is displayed. The user must evaluate the expression to determine the time. It can be used as a device by students, scientists, programmers, mathematicians, the elderly, or others to exercise their mind by doing mathematical calculations.

### Advantages

The method and apparatus of this application is significantly different from prior art in that it is designed to be difficult to read, and actually requires some thought to be able to determine the time of day. Its appeal is the fact that it presents a different mental exercise to the user at various intervals, such as every minute.

Early clocks were analog, consisting of hands which rotate around a dial, with the positions of the hands indicating the hours and minutes. With the advent of computers and digital electronics, many timepieces are now digital, which numerically display the hours and minutes and sometimes the seconds such as 1:15, 10:43, 2:17:59, etc. Very little, if any, thought is required to read the time of day from a digital timepiece. Allowing computers to do the thinking relieves humans from having to do it, but is leading to new generations of people who lack basic thinking skills, particularly in the field of mathematics. In 2006, the United States National Academies published an alarming report on the decline in math and science education in the United States, and developed several recommendations to reinvigorate interest in these fields.

In addition, recent studies have found that elderly people can benefit from frequent mental exercises, to help keep the brain sharp, stimulate the mind, and help reduce the risk of developing neurodegenerative diseases and dementia. The Alzheimer's Association, at http://www.alz.org/we_can_help_stay_mentally_active.asp (valid as of March 2013), states that “Mental decline as you age appears to be largely due to altered connections among brain cells. But research has found that keeping the brain active seems to increase its vitality and may build its reserves of brain cells and connections. You could even generate new brain cells.” The association advocates keeping one's brain active every day by performing mental exercises, as a method to help prevent or delay the onset of Alzheimer's disease.

An advantage of the method and apparatus described in this application is that it provides a continuous stream of mental exercises for the user. Inherent in the method is the motivation to perform the mathematical exercise in order to determine the time of day.

### SUMMARY

The method and apparatus of this application takes advantage of the fact that digital clocks have become so widespread in use, but displays the time in a completely different way, one which requires some thought. A display capable of showing numbers, letters, and other characters is used. A mathematical expression, consisting of a plurality of numbers in conjunction with one or more mathematical function symbols is displayed. The expression that is displayed changes at various intervals. The evaluation of any displayed mathematical expression according to mathematical conventions yields a number equivalent to the current time of day. For a simple example, the mathematical expression of 26+201 equates to 227 which represents a time of day of 2:27.

The example above evaluates to integers whose least significant two digits represent the minutes and whose most significant digits which represent hours, but this application covers other mathematical expressions as well. An example of a non-integer expression is 5.01+1.22 which equates to 6.23 and represents a time of day of 6:23.

Refer to the drawings document for figure numbers referenced below.

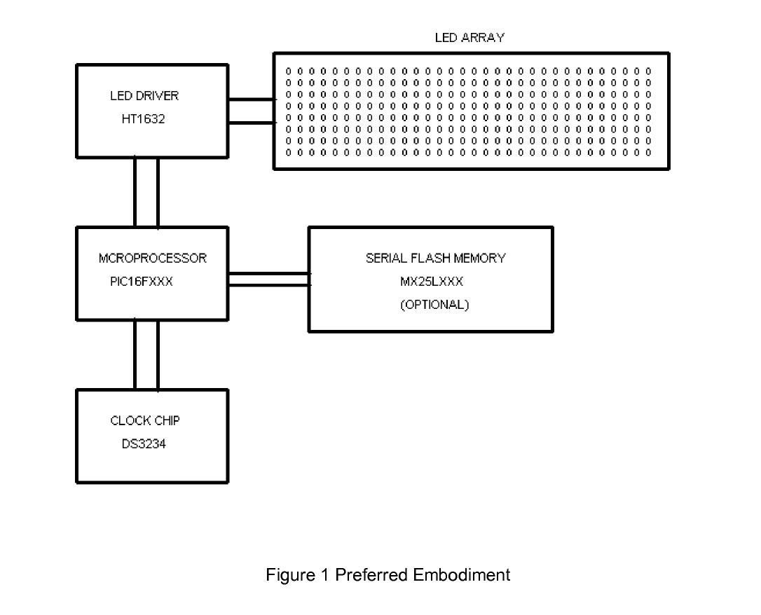

FIG. 1 shows the basic building blocks of the preferred embodiment of the apparatus described in this application. A matrix of LEDs is used in order to visually display letters, numbers and other symbols such as mathematical function symbols. An electronics driver chip supplies power to the correct LEDs and a microprocessor controls the driver by telling it what to display. Optional memory is used to store the mathematical expressions that will be used, and a clock chip provides the time base.

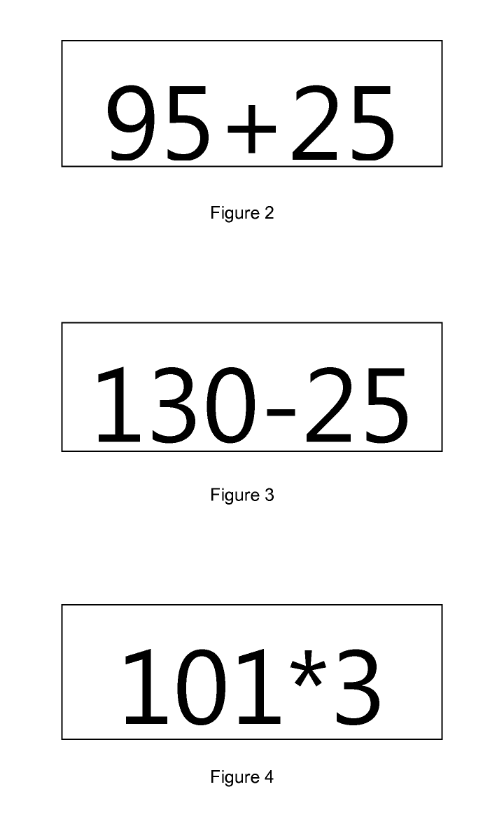

FIG. 2 shows an example of addition expression, resulting in an integer:
95+25=120, representing a time of 1:20

FIG. 3 shows an example of subtraction expression, resulting in an integer:
130−25=105, representing a time of 1:05

FIG. 4 shows an example of multiplication expression, resulting in an integer:
101*3=303, representing a time of 3:03

FIG. 5 shows an example of division expression, resulting in an integer:
830/2=415, representing a time of 4:15

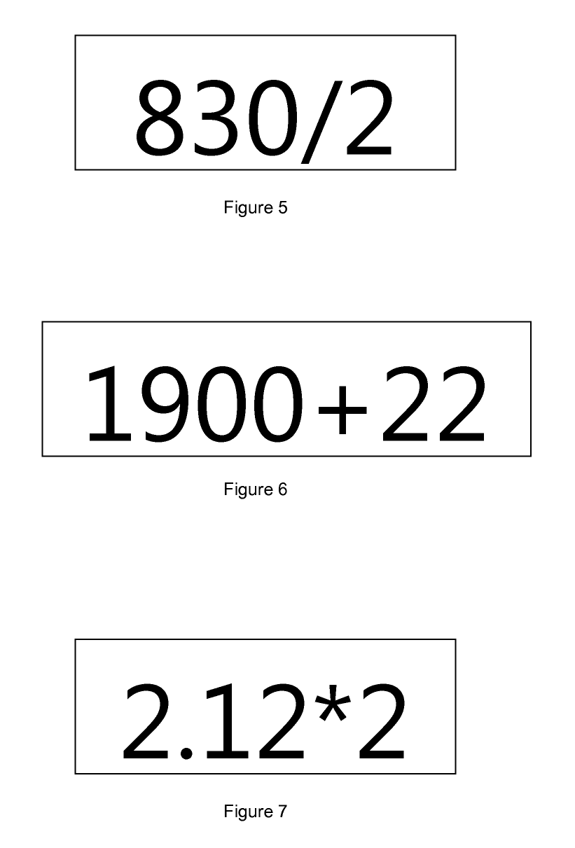

FIG. 6 shows an example of addition expression to show military time, resulting in an integer:
1900+220=2120, representing a time of 21:20

FIG. 7 shows an example of multiplication expression, resulting in a non-integer:
2.12*2=4.24, representing a time of 4:24

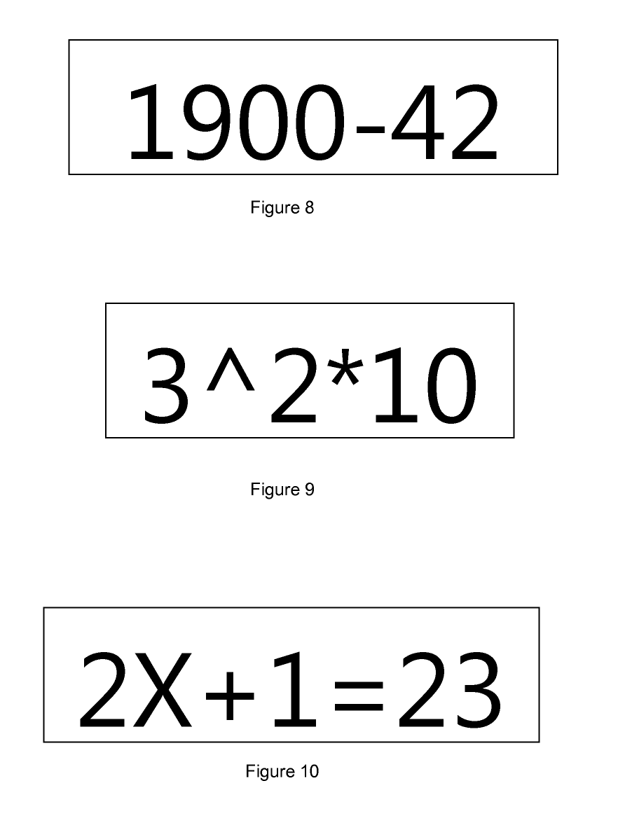

FIG. 8 shows an example of subtraction expression to show military time, resulting in an non-integer:
1900−42=1858, representing a time of 18:58

FIG. 9 shows an example of an expression with multiple mathematical operators:
3̂2*100=3*3*100=900, representing a time of 9:00

FIG. 10 shows an example of algebraic expression which must be solved. Solving the expression yields x=118, representing a time of 1:18

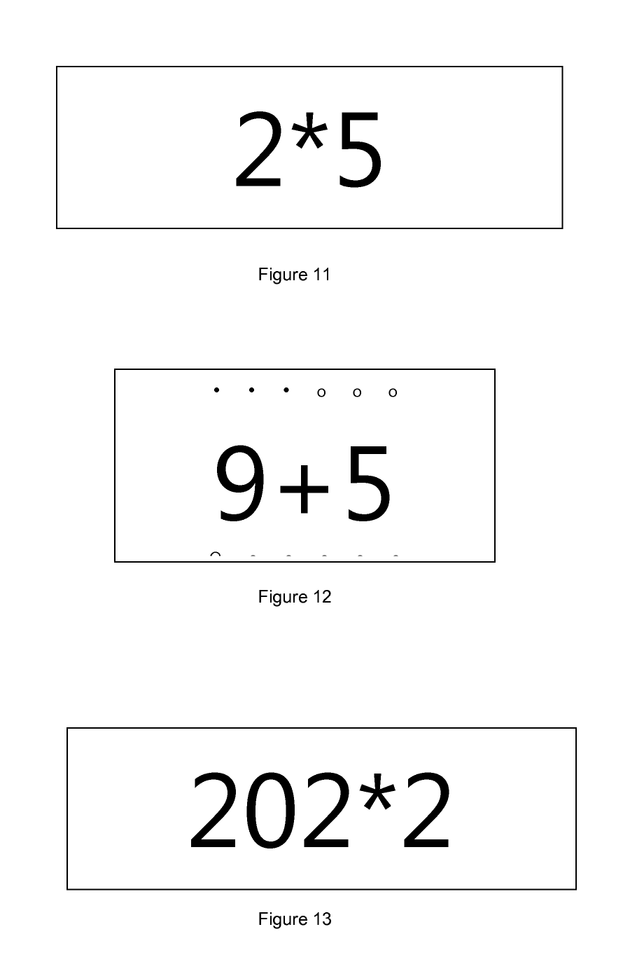

FIG. 11 shows an example of a mathematical expression to represent the hour, and a number of LEDs on to represent the minutes.
2*5=10, and 5 of the 60 LEDs are on, representing a time of 10:05

FIG. 12 shows an example of a mathematical expression to represent the minute, and a number of LEDs on to represent the hour:
3 of the 12 LEDs are on, and 9+5=14, representing a time of 3:14

FIG. 13 shows an example of a mathematical expression resulting in an integer, and a number of LEDs on to represent the seconds:
202*2=404, and 10 of the 60 LEDs are on, representing a time of 4:04:10

### DETAILED DESCRIPTION

This application covers a method or apparatus that displays different mathematical expressions at various intervals. Evaluating any given expression yields a number which represents the current time of day. This is best described through examples as follows:
182+59 equates to: 241, a time of day of 2:41
456−21 equates to: 435, a time of day of 4:35
221*2 equates to: 442, a time of day of 4:42
1284/2 equates to: 642, a time of day of 6:42

The expressions given shown above are relatively simple expressions using the four basic arithmetic functions of addition, subtraction, multiplication and division. In a simple embodiment, just these mathematical functions can be used throughout the day. Different variations of the invention could appeal to different people, depending on the ease or difficulty in which the mathematical expressions can be evaluated.

This application is not limited to using simple mathematical expressions using addition, subtraction, multiplication and division but could also include more complicated expressions such as:
10̂2+24 which equates to:
10 squared plus 24=100+24=124, a time of day of 1:24
√144+1000 which equates to:
square root of 144+1000=12+1000=1012, a time of day of 10:12
   |78−695| which equates to:
absolute value of (−617)=617, a time of day of 6:17
6!+5 which equates to:
6 factorial+5=720+5=725, a time of day of 7:25.

Military time with hours numbered from 0 to 23 instead of 1 to 12 can also be represented such as: 12*12*10 which equates to: 1440 or a time of day of 14:40 The number and type of expressions that can be used to represent any given time of day is limited only by the capability of the driving electronics and the size of the display, which this application imposes no limits on.

The example expressions given to this point all evaluate to integers, the least significant two representing the minutes and the most significant one or two representing the hours. In another embodiment, expressions which evaluate to non-integers could be used such as 3.12-0.1 which equates to 3.02 or a time of 3:02. In this case, the resulting number to the left of the decimal point represents the hour and the numbers to the right of the decimal point represent the minutes.

In yet another embodiment, a single variable algebraic equation could be displayed such as: 3x+1=670. Solving this equation for the variable x, yields x=223, which represents a time of 2:23. Any combination of numbers and mathematical functions could be used in such equations. With a large enough display, two equations with two unknowns can be displayed. Solving the set of equations for the two unknowns would yield the current hour and minute.

It may be desirable, especially for expressions that are more difficult to evaluate, to have a seconds indicator such as a circle or line of LEDs which come on or go off sequentially. The user would then know that he has a limited time, such as one minute, to evaluate the expression and determine the time, before he is presented with a new expression to evaluate.

In another embodiment, the displayed mathematical expression represents only the hour, and the minute is represented by other means such as a rotating minute hand, a static number, or a sequence of LEDs. Such a device gives the viewer a longer time, up to one hour, to evaluate the expression, yet still be able to easily track the passage of minutes at a glance. This device differs from other analog clocks on the market that show an equation for the hour, in that the expression that represents the hour is not static. For example, 3*3 could be displayed for 9:00, but 12 hours later a completely different expression such as 5+4 could be displayed.

Finally, in another embodiment, the displayed mathematical expression represents only the minute, and the hour is represented by other means such as a rotating hour hand, a static number, or a sequence of LEDs. Such a device gives the viewer a way to determine approximate time (the hour) at a glance, but will need to evaluate the expression in order to determine the minute.

What is claimed as invention is:

1. A timepiece comprising:
a. A display capable of showing numbers and mathematical symbols
b. A control circuit capable of controlling the data on said display
c. A circuit or software which uses said display to show a plurality of numbers and one or more mathematical function symbols to display a mathematical expression, which when evaluated according to mathematical conventions, yields a number which represents the time of day.
d. A circuit or software which changes the mathematical expression on said display at various intervals, to track the passage of time.

2. The timepiece of claim 1 wherein said mathematical expression evaluates to an integer value between 100 and 1259, the least significant two digits of the number representing the minutes, and the most significant one or two digits representing the hour in an ante-meridiem (a.m.) and post-meridiem (p.m.) system.

3. The timepiece of claim 1 wherein said mathematical expression evaluates to an integer value between 0000 and 2359, filling with leading zeroes if necessary, the least significant two digits of the number representing the minutes, and the most significant one or two digits, representing the hour in a Military or 24-hour system.

4. The timepiece of claim 1 wherein said mathematical expression evaluates to a number between 1.00 and 12.59, the first two digits to the right of the decimal point representing the minutes, and the one or two digits to the left of the decimal point representing the hour in an ante-meridiem (a.m.) and post-meridiem (p.m.) system.

5. The timepiece of claim 1 wherein said mathematical expression evaluates to a number between 0.00 and 23.59, the first two digits to the right of the decimal point representing the minutes, and the one or two digits to the left of the decimal point representing the hour in a Military or 24-hour system.

6. The timepiece of claim 1 wherein said mathematical expression evaluates to a number between 1 and 12, representing the current hour in an ante-meridiem (a.m.) and post-meridiem (p.m.) system.

7. The timepiece of claim 1 wherein said mathematical expression evaluates to a number between 0 and 23, representing the current hour in a Military or 24-hour system.

8. The timepiece of claim 1 wherein said mathematical expression evaluates to a number between 0 and 59, representing the current minute.

9. The timepiece of claim 1 wherein said mathematical expression is an equation with an unknown value, which when the equation is solved, the originally unknown value represents the time of day.

10. The timepiece of claim 1 with further circuitry and display elements to display the passing of seconds along with the mathematical expression.

11. The timepiece of claim 1 wherein said display is a Liquid Crystal Display (LCD) type.

12. The timepiece of claim 1 wherein said display is an array of Light Emitting Diodes (LEDs).

13. A method of displaying the time of day, comprising:
a. Determining the current time of day
b. Creating a mathematical expression using a plurality of numbers and one or more mathematical operators, such that evaluating the expression yields a number which represents the time of day

14. The method of claim 13 wherein said mathematical expression evaluates to an integer value between 100 and 1259, the least significant two digits of the number representing the minutes, and the most significant one or two digits representing the hour in an ante-meridiem (a.m.) and post-meridiem (p.m.) system.

15. The method of claim 13 wherein said mathematical expression evaluates to an integer value between 0000 and 2359, filling with leading zeroes if necessary, the least significant two digits of the number representing the minutes, and the most significant one or two digits, representing the hour in a Military or 24-hour system.

16. The method of claim 13 wherein said mathematical expression evaluates to a number between 1.00 and 12.59, the first two digits to the right of the decimal point representing the minutes, and the one or two digits to the left of the decimal point representing the hour in an ante-meridiem (a.m.) and post-meridiem (p.m.) system.

17. The method of claim 13 wherein said mathematical expression evaluates to a number between 0.00 and 23.59, the first two digits to the right of the decimal point representing the minutes, and the one or two digits to the left of the decimal point representing the hour in a Military or 24-hour system.
